(19) United States
(12) Patent Application Publication
(10) Pub. No.: US 2026/0009640 A1
(43) Pub. Date: Jan. 8, 2026

(54) AUTONOMOUS FUSION TRACKING METHOD BASED ON SENSORS OF PHOTOELECTRIC THEODOLITE

(71) Applicant: Changchun Institute Of Optics, Fine Mechanics And Physics, Chinese Academy Of Sciences, CHANGCHUN (CN)

(72) Inventors: SHIXUE ZHANG, CHANGCHUN (CN); HOUFENG WANG, CHANGCHUN (CN); HONGWEN LI, CHANGCHUN (CN); JINYU ZHAO, CHANGCHUN (CN); LIDUO SONG, CHANGCHUN (CN)

(21) Appl. No.: 19/189,983

(22) Filed: Apr. 25, 2025

(30) Foreign Application Priority Data
Jul. 5, 2024 (CN) 202410897974.8

(51) Int. Cl. G01C 1/04

(52) U.S. Cl. CPC G01C 1/04

(57) ABSTRACT

An autonomous fusion tracking method based on sensors of a photoelectric theodolite includes steps of calculating least square extrapolation values of each of the sensors at a current moment and average values of the measurement values of the sensors at the current moment; substituting the least square extrapolation values respectively into improved error covariance recursive formulas, and calculating error covariances of each of the sensor at the current moment in real time based on the improved error covariance recursive formulas, and calculating weighting factors of each of the sensors at the current moment in real time according to the error covariances of each of the sensors at the current moment; constructing a tri-state discrimination model; and performing, by the photoelectric theodolite, autonomous fusion tracking on a to-be-measured target based on the tri-state discrimination model to obtain a tracking result. The method realizes an automatic operation of the photoelectric theodolite.

### TECHNICAL FIELD

The present disclosure relates to a technical field of photoelectric theodolite data processing, and in particular to an autonomous fusion tracking method based on sensors of a photoelectric theodolite.

### BACKGROUND

A photoelectric theodolite is an instrument of angle measurement system based on optical principles. A main task of the photoelectric theodolite is to combine a precise optical system thereof and high-precision sensors thereof to obtain images of a high-speed moving target such as a missile or a rocket, and to measure parameters such as a trajectory and a posture of the high-speed moving target. In order to improve a detection capability of the photoelectric theodolite, the photoelectric theodolite is commonly integrated with sensors with different parameters such as different working bands and focal lengths. At present, when using the sensors to automatically track a target in a closed loop, a common method is to manually select data with highest image clarity and most stable observation of one of the sensors and send the data to an on-board servo. However, if the switch is not timely, the target is easily lost. Therefore, a switching process is heavily dependent on the operator's experience and it is difficult to meet requirements of an automatic operation of the photoelectric theodolite. In addition, unsmooth transition of measurement data of different sensors affects the stable operation of the photoelectric theodolite.

At present, although there are many algorithms for adaptive weighting of the sensors, they are rarely used in optical measurement equipment such as the photoelectric theodolite. A main reason is that an observation angle of the photoelectric theodolite changes all the time during a tracking process of the target, and a fusion tracking method needs to reflect data quality of each of the sensors in time. Further, the fusion tracking methods in conventional research are generally in isolation and fail to combine with a photoelectric theodolite tracking system. Therefore, how to effectively use the sensors and manage fused information so that the photoelectric theodolite is able to operate stably when tracking the target is a problem to be solved by the current fusion tracking methods.

### SUMMARY

In view of defects in the prior art, the present disclosure aims to provide an autonomous fusion tracking method based on sensors of a photoelectric theodolite to solve a problem that sensors of a photoelectric theodolite in the prior art are not effectively utilized to realize autonomous fusion tracking of a to-be-measured target. The present disclosure realizes an automatic operation of the photoelectric theodolite and improves a stable tracking capability of the photoelectric theodolite.

To achieve the above object, technical solutions of the present disclosure provide an autonomous fusion tracking method based on sensors of a photoelectric theodolite. The autonomous fusion tracking method comprises:
a step S1: reading measurement values and miss distance valid bits of each of the sensors in real time, and calculating least square extrapolation values of each of the sensors at a current moment and average values of the measurement values of the sensors at the current moment according to real-time reading results;
a step S2: substituting the least square extrapolation values respectively into improved error covariance recursive formulas, and calculating error covariances of each of the sensors at the current moment in real time based on the improved error covariance recursive formulas, and calculating weighting factors of the sensors at the current moment in real time according to the error covariances of each of the sensors at the current moment;
a step S3: constructing a tri-state discrimination model; and
a step S4: performing, by the photoelectric theodolite, autonomous fusion tracking on a to-be-measured target based on the tri-state discrimination model to obtain a tracking result.

Furthermore, the measurement values of each of the sensors comprise the azimuth angle measurement value and the pitch angle measurement value. The least square extrapolation values of each of the sensors comprise the azimuth least square extrapolation value and the pitch least square extrapolation value. The improved error covariance recursive formulas comprise an improved azimuth error covariance recursive formula and an improved pitch error covariance recursive formula. The error covariances of each of the sensors comprise an azimuth error covariance and a pitch error covariance. The weighting factors of each of the sensors comprise the azimuth weighting factor and the pitch weighting factor.

Furthermore, the step S1 comprises:
a step S11: sorting priorities of the sensors according to measurement precision of the sensors, and reading an azimuth angle measurement value, a pitch angle measurement value and a miss distance valid bit of each of the sensors at the current moment;
a step S12: determining whether there are sensors with true miss distance valid bits in the current moment, if yes, executing a step S13, if not, executing the step S11 and reading an azimuth angle measurement value, a pitch angle measurement value and a miss distance valid bit of each of the sensors at a next moment;
the step S13: obtaining the number of fusion values from a moment k−N_{fit}−k−1 of each of the sensors with the true miss distance valid bits, if each of the sensors with the true miss distance valid bits has N_{fit} fusion values from the moment k−N_{fit}−k−1, executing a step S14, and if not, executing a step S15;
the step S14: calculating an azimuth least square extrapolation value of each of the sensors with the true miss distance valid bits and a pitch least square extrapolation value of each of the sensors with the true miss distance valid bits at the current moment k by following formulas, and executing a step S2;

$${X}_{ap} ( k ) = {\sum }_{t = k - {N}_{fit}}^{k - 1} β ( t ) {X}_{af} ( t ) ;$$

$${X}_{bp} ( k ) = {\sum }_{t = k - {N}_{fit}}^{k - 1} β ( t ) {X}_{bf} ( t ) ;$$

where β(t) is a coefficient, N_{fit} is the number of the fusion values required for fitting extrapolation values, Xₐₚ(k) is the azimuth least square extrapolation value at the current moment k, X_{bp}(k) is the pitch least square extrapolation value at the current moment k, X_{af}(t) is fusion values from the moment k−N_{fit}−k−1 in an azimuth dimension, and X_{bf}(t) is fusion values at the moment k−N_{fit}−k−1 in a pitch dimension; and
the step S15: calculating an average value of the azimuth angle measurement values of the sensors with the true miss distance valid bits at the current moment k and an average value of the pitch angle measurement values of the sensors with the true miss distance valid bits at the current moment k, defining the average value of the azimuth angle measurement values of the sensors with the true miss distance valid bits at the current moment k as a fusion value from the moment k−N_{fit}−k−1 in the azimuth dimension, defining the average value of the pitch angle measurement values of the sensors with the true miss distance valid bits at the current moment k as a fusion value from the moment k−N_{fit}−k−1 in the pitch dimension, taking a reciprocal of a total number of the sensors with the miss distance valid bits at the current moment as an azimuth weighting factor and a pitch weighting factor at the current moment, and executing the step S3.

Furthermore, the improved azimuth error covariance recursive formula and the improved pitch error covariance recursive formula are as follow:

$${\hat{σ}}_{ai}^{2} ( k ) = a {\hat{σ}}_{ai}^{2} ( k - 1 ) + ( 1 - a ) {( {X}_{ai} ( k ) - {X}_{ap} ( k ) )}^{2} ; and$$

$${\hat{σ}}_{bi}^{2} ( k ) = a {\hat{σ}}_{bi}^{2} ( k - 1 ) + ( 1 - a ) {( {X}_{bi} ( k ) - {X}_{bp} ( k ) )}^{2} .$$

$${\hat{σ}}_{ai}^{2} ( k )$$

is an error covariance or an i-th sensor in the azimuth dimension at the current moment k.

$${\hat{σ}}_{ai}^{2} ( k - 1 )$$

is an error covariance or the i-th sensor in the azimuth dimension at the (k−1)-th moment.

$${\hat{σ}}_{bi}^{2} ( k )$$

is an error covariance of the i-th sensor in the pitch dimension at the current moment k.

$${\hat{σ}}_{bi}^{2} ( k - 1 )$$

is an error covariance of the i-th sensor in the pitch dimension at the (k−1)-th moment. α is an attenuation factor and is 0.95. Xₐᵢ(k) is an azimuth angle measurement value of the i-th sensor at the current moment k. X_{bi}(k) is a pitch angle measurement value of the i-th sensor at the current moment k. Xₐₚ(k) is a least square extrapolation value at the current moment k in the azimuth dimension, and X_{bp}(k) is a least square extrapolation value at the current moment k in the pitch dimension.

Furthermore, in the step S4, the tri-state discrimination model is configured to discriminate a working state of each of the sensors to be discriminated, and the working state of each of the sensors to be discriminated comprises a holding state, a fused state, and a switching state.

Furthermore, the step S2 comprises:
a step S21: respectively substituting a real-time azimuth angle measurement value and a real-time pitch angle measurement value of each of the sensors into the improved azimuth error covariance recursive formula and the improved pitch error covariance recursive formula, and calculating the azimuth error covariance and the pitch error covariance of each of the sensors at the current moment in real time by the improved azimuth error covariance recursive formula and the improved pitch error covariance recursive formula; and
a step S22: substituting the azimuth error covariance and the pitch error covariance of each of the sensors at the current moment into following formulas to obtain the azimuth weighting factor and the pitch weighting factor of each of the sensors at the current moment:

$${w}_{a i} = \frac{1}{\vert {\hat{σ}}_{a i}^{2} {\sum }_{i = 1}^{n} 1 / {\hat{σ}}_{a i}^{2} ( k ) \vert} ; and$$

$${w}_{b i} = \frac{1}{\vert {\hat{σ}}_{b i}^{2} {\sum }_{i = 1}^{n} 1 / {\hat{σ}}_{b i}^{2} \vert} .$$

Wₐᵢ is an azimuth weighting factor of the i-th sensor. W_{bi} is a pitch weighting factor of the i-th sensor, and n is a total number of the sensors of the photoelectric theodolite.

Furthermore, determination steps of the tri-state discrimination model in the step S3 comprise:
a step S3A1: defining a time window as L time sampling points including the current moment, and calculating a residual error absolute value Mₐᵢ(t) of the error covariance of the azimuth angle measurement value and a residual error absolute value M_{bi}(t) of the error covariance of the pitch angle measurement value;
a step S3A2: reading the azimuth angle measurement value and the pitch angle measurement value of a current to-be-discriminated sensor in the time window;
a step S3A3: determining whether there are L time sampling points in the time window of the current to-be-discriminated sensor, if yes, executing a step S3A4, if not, executing the step S3A2 until there are L time sampling points in the time window of the current to-be-discriminated sensor;
the step S3A4: when the residual error absolute values Mₐᵢ(t) or the residual error absolute value M_{bi}(t) of each of the time sampling points of the current to-be-discriminated sensor in the time window is greater than a first threshold; or when there is the residual error absolute values Mₐᵢ(t) or the residual error absolute value M_{bi}(t) of the current to-be-discriminated sensor in the time window that is greater than the first threshold, and the azimuth weighting factor and the pitch weighting factor of each of the time sampling points are less than a second threshold, determining that the current to-be-discriminated sensor is in the switching state and executing a step S3A6, otherwise, performing a next determination step on the current to-be-discriminated sensor and executing a step S3A5;
the step S3A5: when the residual error absolute values Mₐᵢ(t) and the residual error absolute value M_{bi}(t) of each of the time sampling points of the current to-be-discriminated sensor in the time window are less than the first threshold; or when there are the residual error absolute values Mₐᵢ(t) and the residual error absolute value M_{bi}(t) of the current to-be-discriminated sensor in the time window that are less than the first threshold, and the azimuth weighting factor and the pitch weighting factor of each of the time sampling points are greater than the second threshold, determining that the current to-be-discriminated sensor is in the holding state, otherwise, determining that the current to-be-discriminated sensor is in the fused state; and
the step S3A6: repeating the steps S3A2-S3A5 to realize a tri-state discrimination of all of the sensors to be discriminated.

Furthermore, a formula for calculating the residual error absolute value Mₐᵢ(t) of the error covariance of the azimuth angle measurement value obtained according to the azimuth angle measurement value of the sensors to be discriminated at the current moment is:

$${M}_{a i} ( t ) = \vert {X}_{a i} ( t ) - {X}_{a p} ( t ) \vert ..$$

Xₐᵢ(t) is the azimuth angle measurement value of one of the sampling points at a t moment of each of the sensors to be discriminated, t=k−L+1, k−L+2, . . . , k, L is a length of the time window, k is the current moment, and Xₐₚ(t) is the azimuth least square extrapolation value of each of the sensors to be discriminated at the moment t.

A formula for calculating the residual error absolute value M_{bi}(t) of the error covariance of the pitch angle measurement value obtained according to the pitch angle measurement value of each of the sensors to be discriminated at the current moment is:

$${M}_{b i} ( t ) = \vert {X}_{b i} ( t ) - {X}_{b p} ( t ) \vert .$$

X_{bi}(t) is the pitch angle measurement value of each of the sensors to be discriminated at the moment t, and X_{bp}(t) is the pitch least square extrapolation value of each of the sensors to be discriminated at the moment t.

Another formula for calculating the residual error absolute value Mₐᵢ(t) of the error covariance of the azimuth angle measurement value obtained according to the azimuth angle measurement value of the sensors to be discriminated at the current moment is:

$${M}_{a i} ( t ) = \vert {X}_{a i} ( t ) - {X}_{a f} ( t ) \vert .$$

X_{af}(t) is a fusion value from the t−N_{fit}−t−1 moment in the azimuth dimension.

Another formula for calculating the residual error absolute value M_{bi}(t) of the error covariance of the pitch angle measurement value obtained according to the pitch angle measurement value of each of the sensors to be discriminated at the current moment is:

$${M}_{b i} ( t ) = \vert {X}_{b i} ( t ) - {X}_{b f} ( t ) \vert .$$

X_{bf}(t) is a fusion value from the t−N_{fit}−t−1 moment in the pitch dimension.

Furthermore, the step S4 comprises:
a step S41: determining whether the miss distance valid bits output by each of the sensors with the true miss distance valid bits in the time window comprises non-true miss distance valid bits, if yes, outputting the azimuth angle measurement value and the pitch angle measurement value of one of the sensors with the highest priority and executing a step S43, if not, taking sensors only with the true miss distance valid bits in the time window as to-be-selected sensors and executing a step S42;
the step S42: sorting priorities of the to-be-selected sensors according to the measurement precision, determining the working state of each of the to-be-selected sensors at the current moment by using the tri-state discrimination model, and outputting a current tracking result of the to-be-measured target by the photoelectric theodolite according to discrimination results; and
the step S43: determining whether to continue to perform autonomous fusion tracking on the to-be-measured target, if yes, repeating the steps S41-S42, and if not, ending autonomous fusion tracking of the to-be-measured target.

Furthermore, the step S42 comprises:
a step S421: if an output value at a previous moment is a fusion value, outputting the azimuth angle measurement value and the pitch angle measurement value of one of the to-be-selected sensors with the highest priority at the current moment, otherwise, outputting output values at the previous moment as the azimuth angle measurement value and the pitch angle measurement value of each of the to-be-selected sensors and executing a step S422; and
the step S422: if the state of each of the to-be-selected sensors that outputs the azimuth angle measurement value and the pitch angle measurement value at the previous moment is in the fused state at the current moment, outputting an azimuth angle fusion value and a pitch angle fusion value of the to-be-selected sensors with the true valid bits at the current moment, otherwise, outputting the azimuth angle measurement value and the pitch angle measurement value of the one of the to-be-selected sensors with the highest priority at the current moment.

Furthermore, formulas for calculating the azimuth angle fusion value and the pitch angle fusion value are as follow:

$${\hat{X}}_{a} = {\sum }_{i = 1}^{c} {w}_{ai} {X}_{ai} ; and$$

$${\hat{X}}_{b} = {\sum }_{i = 1}^{c} {w}_{bi} {X}_{bi} .$$

\hat{X}ₐ is the azimuth angle fusion value, and \hat{X}_{b} is the pitch angle fusion value.

Compared with the prior art, the autonomous fusion tracking method of the present disclosure innovatively constructs the tri-state discrimination model. The tri-state discrimination model effectively evaluates data quality of the measurement values of each of the sensors. The present disclosure does not need to know the prior knowledge of the photoelectric theodolite. It only needs to perform real-time recursion according to the measurement values of each of the sensors during the tracking process to obtain a switching selection and a measurement output decision of each of the sensors, thereby realizing the automatic operation of the photoelectric theodolite and improving the stable tracking capability of the photoelectric theodolite.

### BRIEF DESCRIPTION OF DRAWINGS

The drawings constituting a part of the present disclosure are used to provide a further understanding of the present disclosure. The exemplary embodiments of the present disclosure and descriptions thereof are used to explain the present disclosure and do not constitute an improper limitation on the present disclosure.

FIG. 1 is a flow chart of an autonomous fusion tracking method based on sensors of a photoelectric theodolite according to one embodiment of the present disclosure.

FIG. 2 is a schematic diagram of arrangements of miss distance valid bits continuously output by four sensors according to one embodiment of the present disclosure.

### DETAILED DESCRIPTION

In order to make technical problems, technical solutions, and beneficial effects to be solved by the present disclosure clearer, the present disclosure is further described in detail below in conjunction with accompanying drawings and embodiments. It should be understood that the specific embodiments described herein are only used to explain the present disclosure and are not used to limit the present disclosure.

It should be noted that in the case of no conflict, the embodiments of the present disclosure and the features in the embodiments may be combined with each other.

It should be understood that in the description of the present disclosure terms such as “central”, “lateral”, “lengthways”, “length”, “width”, “thickness”, “upper”, “lower”, “left”, “right”, “vertical”, “horizontal”, “top”, “bottom”, “inner”, “outer”, “clockwise”, “counterclockwise”, etc. indicate direction or position relationships shown based on the drawings, and are only intended to facilitate the description of the present disclosure and the simplification of the description rather than to indicate or imply that the indicated device or element must have a specific direction or be constructed and operated in a specific direction, and therefore, shall not be understood as a limitation to the present disclosure. In addition, terms such as “first” and “second” are only used for the purpose of description, rather than being understood to indicate or imply relative importance or hint the number of indicated technical features. Thus, the feature limited by “first” and “second” can explicitly or implicitly include one or more features. In the description of the present disclosure, the meaning of “a plurality of” is two or more unless otherwise specified.

It should be noted in the description of the present disclosure that, unless otherwise regulated and defined, terms such as “installation,” “bonded,” and “connection” shall be understood in a broad sense, and for example, may refer to fixed connection or detachable connection or integral connection; may refer to mechanical connection or electrical connection; and may refer to direct connection or indirect connection through an intermediate medium or inner communication of two elements. For those of ordinary skill in the art, the meanings of the above terms in the present disclosure may be understood according to concrete conditions.

The present disclosure is described in detail below with reference to the accompanying drawings and in combination with the embodiments.

A photoelectric theodolite integrates sensors with different parameters such as different working bands and different focal lengths, and the sensors comprise a visible light camera, a near-infrared camera, a medium-wave infrared camera, a long-wave infrared camera, etc. A single sensor is only able to observe a target within a certain range. Affected by environmental interference and imaging quality of the detector, the single sensor may not reflect a true state of the to-be measured target, or even lose the to-be measured target. For example, a resolution of the visible light camera is high, but lighting requirements are high, while the infrared camera is able to effectively observe the to-be measured target through clouds and fog, but a spatial resolution is low. If the complementary characteristics of different sensors are fully utilized to perform data fusion of the sensors, measurement uncertainty of the single sensor is overcome, and consistent observation of the to-be measured target is achieved.

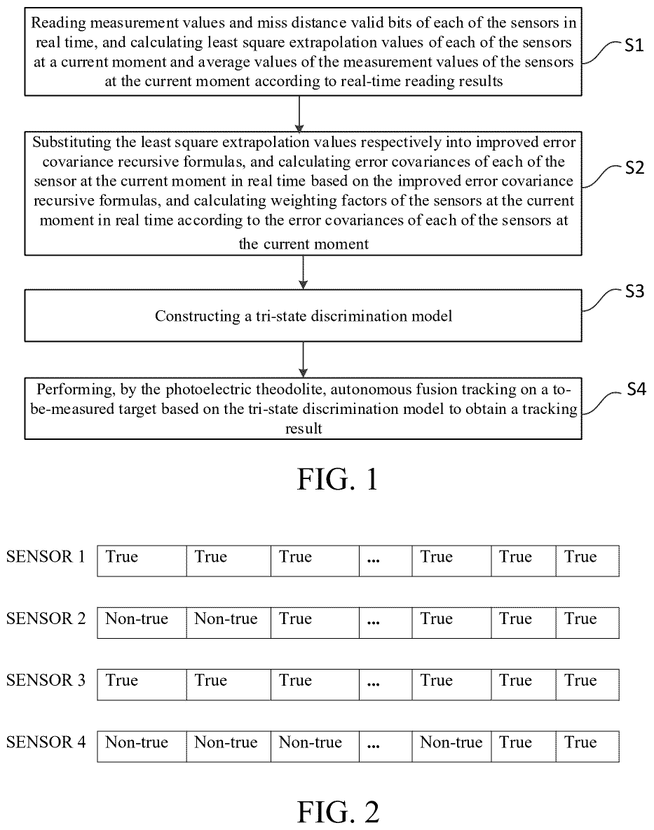

As shown in FIG. 1, the present disclosure provides an autonomous fusion tracking method based on sensors of a photoelectric theodolite. The autonomous fusion tracking method comprises steps S1-S4.

The step S1 comprises reading measurement values and miss distance valid bits of each of the sensors in real time, and calculating least square extrapolation values of each of the sensors at a current moment and average values of the measurement values of the sensors at the current moment according to real-time reading results.

The step S1 specifically comprises steps S11-S15.

The step S11 comprises sorting priorities of the sensors according to measurement precision of the sensors, and reading an azimuth angle measurement value, a pitch angle measurement value and a miss distance valid bit of each of the sensors at the current moment.

The step S12 comprises determining whether there are sensors with true miss distance valid bits in the current moment, if yes, executing the step S13, if not, executing the step S11 and reading an azimuth angle measurement value, a pitch angle measurement value and a miss distance valid bit of each of the sensors at a next moment.

The step S13 comprises obtaining the number of fusion values from a moment k−N_{fit}−k−1 of each of the sensors with the true miss distance valid bits, if each of the sensors with the true miss distance valid bits has N_{fit} fusion values from the moment k−N_{fit}−k−1, executing the step S14; and if not, executing the step S15.

The step S14 comprises calculating an azimuth least square extrapolation value of each of the sensors with the true miss distance valid bits and a pitch least square extrapolation value of each of the sensors with the true miss distance valid bits at the current moment k by following formulas, and executing the step S2:

$${X}_{a p} ( k ) = {\sum }_{t = k - {N}_{f i t}}^{k - 1} β ( t ) {X}_{a f} ( t ) ; and$$

$${X}_{b p} ( k ) = {\sum }_{t = k - {N}_{f i t}}^{k - 1} β ( t ) {X}_{b f} ( t ) .$$

β(t) is a coefficient, N_{fit} is the number of the fusion values required for fitting extrapolation values, Xₐₚ(k) is the azimuth least square extrapolation value at the current moment k, X_{bp}(k) is the pitch least square extrapolation value at the current moment k, X_{af}(t) is fusion values from the moment k−N_{fit}−k−1 in an azimuth dimension, and X_{bf}(t) is fusion values at the moment k−N_{fit}−k−1 in a pitch dimension.

The step S15 comprises calculating an average value of the azimuth angle measurement values of the sensors with the true miss distance valid bits at the current moment k and an average value of the pitch angle measurement values of the sensors with the true miss distance valid bits at the current moment k, defining the average value of the azimuth angle measurement values of the sensors with the true miss distance valid bits at the current moment k as a fusion value from the moment k−N_{fit}−k−1 in the azimuth dimension, defining the average value of the pitch angle measurement values of the sensors with the true miss distance valid bits at the current moment k as a fusion value from the moment k−N_{fit}−k−1 in the pitch dimension, taking a reciprocal of a total number of the sensors with the miss distance valid bits at the current moment as an azimuth weighting factor and a pitch weighting factor at the current moment, and executing the step S3.

The step S2 comprises substituting the least square extrapolation values respectively into improved error covariance recursive formulas, and calculating error covariances of each of the sensors at the current moment in real time based on the improved error covariance recursive formulas, and calculating weighting factors of the sensors at the current moment in real time according to the error covariances of each of the sensors at the current moment.

Furthermore, the step S2 specifically comprises steps S21-S22.

The step S21 comprises respectively substituting a real-time azimuth angle measurement value and a real-time pitch angle measurement value of each of the sensors into the improved azimuth error covariance recursive formula and the improved pitch error covariance recursive formula, and calculating the azimuth error covariance and the pitch error covariance of each of the sensors at the current moment in real time by the improved azimuth error covariance recursive formula and the improved pitch error covariance recursive formula.

The improved azimuth error covariance recursive formula and the improved pitch error covariance recursive formula are as follow:

$${\hat{σ}}_{a i}^{2} ( k ) = a {\hat{σ}}_{a i}^{2} ( k - 1 ) + ( 1 - a ) {( {X}_{a i} ( k ) - {X}_{a p} ( k ) )}^{2} ; and$$

$${\hat{σ}}_{b i}^{2} ( k ) = a {\hat{σ}}_{b i}^{2} ( k - 1 ) + ( 1 - a ) {( {X}_{b i} ( k ) - {X}_{b p} ( k ) )}^{2} .$$

$${\hat{σ}}_{a i}^{2} ( k )$$

is an error covariance of an i-th sensor in the azimuth dimension at the current moment k.

$${\hat{σ}}_{a i}^{2} ( k - 1 )$$

is an error covariance or the i-th sensor in the azimuth dimension at the (k−1)-th moment.

$${\hat{σ}}_{b i}^{2} ( k )$$

is an error covariance of the i-th sensor in the pitch dimension at the current moment k.

$${\hat{σ}}_{b i}^{2} ( k - 1 )$$

is an error covariance of the i-th sensor in the pitch dimension at the (k−1)-th moment. α is an attenuation factor and is 0.95. Xₐᵢ(k) is an azimuth angle measurement value of the i-th sensor at the current moment k. X_{bi}(k) is a pitch angle measurement value of the i-th sensor at the current moment k. Xₐₚ(k) is a least square extrapolation value at the current moment k in the azimuth dimension, and X_{bp}(k) is a least square extrapolation value at the current moment k in the pitch dimension.

The step S22 comprises substituting the azimuth error covariance and the pitch error covariance of each of the sensors at the current moment into following formulas to obtain the azimuth weighting factor and the pitch weighting factor of each of the sensors at the current moment:

$${w}_{a i} = \frac{1}{\vert {\hat{σ}}_{a i}^{2} {\sum }_{i = 1}^{n} 1 / {\hat{σ}}_{a i}^{2} ( k ) \vert} ; and$$

$${w}_{b i} = \frac{1}{\vert {\hat{σ}}_{b i}^{2} {\sum }_{i = 1}^{n} 1 / {\hat{σ}}_{b i}^{2} \vert} .$$

Wₐᵢ is an azimuth weighting factor of the i-th sensor. W_{bi} is a pitch weighting factor of the i-th sensor, and n is a total number of the sensors of the photoelectric theodolite.

The step S3 comprises constructing a tri-state discrimination model.

Determination steps of the tri-state discrimination model in the step S3 comprise steps S3A1-S3A6.

The step S3A1 comprises defining a time window as L time sampling points including the current moment, and calculating a residual error absolute value Mₐᵢ(t) of the error covariance of the azimuth angle measurement value and a residual error absolute value M_{bi}(t) of the error covariance of the pitch angle measurement value.

There are two ways to calculate the weighting factors (including the azimuth weighting factor and the pitch weighting factor. A first way is to calculate the least square extrapolation values through executing the step S14, and substitute the least square extrapolation values into the step S2 to calculate the weighting factors. A second way is to execute the step S15 and use the reciprocal of the total number of the sensors with true miss amount valid bits at the current moment as the azimuth weighting factor and the pitch weighting factor at the current moment.

If the first way is adopted, the residual error absolute value Mₐᵢ(t) of the error covariance of the azimuth angle measurement value and the residual error absolute value M_{bi}(t) of the error covariance of the pitch angle measurement value are calculated by using the least square extrapolation values. If the second way is adopted, the residual error absolute value Mₐᵢ(t) of the error covariance of the azimuth angle measurement value and the residual error absolute value of the error covariance M_{bi}(t) of the pitch angle measurement value are calculated using the fusion value.

Furthermore, a formula for calculating the residual error absolute value Mₐᵢ(t) of the error covariance of the azimuth angle measurement value obtained according to the azimuth angle measurement value of the sensors to be discriminated at the current moment is:

$${M}_{a i} ( t ) = \vert {X}_{a i} ( t ) - {X}_{a p} ( t ) \vert .$$

Xₐᵢ(t) is the azimuth angle measurement value of one of the sampling points at a t moment of each of the sensors to be discriminated, t=k−L+1, k−L+2, . . . , k, L is a length of the time window, k is the current moment, and Xₐₚ(t) is the azimuth least square extrapolation value of each of the sensors to be discriminated at the moment t.

A formula for calculating the residual error absolute value M_{bi}(t) of the error covariance of the pitch angle measurement value obtained according to the pitch angle measurement value of each of the sensors to be discriminated at the current moment is:

$${M}_{b i} ( t ) = \vert {X}_{b i} ( t ) - {X}_{b p} ( t ) \vert .$$

X_{bi}(t) is the pitch angle measurement value of each of the sensors to be discriminated at the moment t, and X_{bp}(t) is the pitch least square extrapolation value of each of the sensors to be discriminated at the moment t.

Another formula for calculating the residual error absolute value Mₐᵢ(t) of the error covariance of the azimuth angle measurement value obtained according to the azimuth angle measurement value of the sensors to be discriminated at the current moment is:

$${M}_{a i} ( t ) = \vert {X}_{a i} ( t ) - {X}_{a f} ( t ) \vert .$$

X_{af}(t) is a fusion value from the t−N_{fit}−t−1 moment in the azimuth dimension.

Another formula for calculating the residual error absolute value M_{bi}(t) of the error covariance of the pitch angle measurement value obtained according to the pitch angle measurement value of each of the sensors to be discriminated at the current moment is:

$${M}_{bi} ( t ) = \vert {X}_{b i} ( t ) - {X}_{b f} ( t ) \vert .$$

X_{bf}(t) is a fusion value from the t−N_{fit}−t−1 moment in the pitch dimension.

The step S3A2 comprises reading the azimuth angle measurement value and the pitch angle measurement value of a current to-be-discriminated sensor in the time window.

The step S3A3 comprises determining whether there are L time sampling points in the time window of the current to-be-discriminated sensor, if yes, executing the step S3A4, if not, executing the step S3A2 until there are L time sampling points in the time window of the current to-be-discriminated sensor.

The step S3A4 comprises when the residual error absolute values Mₐᵢ(t) or the residual error absolute value M_{bi}(t) of each of the time sampling points of the current to-be-discriminated sensor in the time window is greater than a first threshold, or when there is the residual error absolute values Mₐᵢ(t) or the residual error absolute value M_{bi}(t) of the current to-be-discriminated sensor in the time window that is greater than the first threshold, and the azimuth weighting factor and the pitch weighting factor of each of the time sampling points are less than a second threshold, determining that the current to-be-discriminated sensor is in the switching state and executing the step S3A6, otherwise, performing a next determination step on the current to-be-discriminated sensor and executing the step S3A5.

The step S3A5 comprises when the residual error absolute values Mₐᵢ(t) and the residual error absolute value M_{bi}(t) of each of the time sampling points of the current to-be-discriminated sensor in the time window are less than the first threshold, or when there are the residual error absolute values Mₐᵢ(t) and the residual error absolute value M_{bi}(t) of the current to-be-discriminated sensor in the time window that are less than the first threshold, and the azimuth weighting factor and the pitch weighting factor of each of the time sampling points are greater than the second threshold, determining that the current to-be-discriminated sensor is in the holding state, otherwise, determining that the current to-be-discriminated sensor is in the fused state.

The step S3A6 comprises repeating the steps S3A2-S3A5 to realize a tri-state discrimination of all of the sensors to be discriminated.

The step S4 comprises performing, by the photoelectric theodolite, autonomous fusion tracking on a to-be-measured target based on the tri-state discrimination model to obtain a tracking result.

In the step S4, the tri-state discrimination model is configured to discriminate a working state of each of the sensors to be discriminated, and the working state of each of the sensors to be discriminated comprises a holding state, a fused state, and a switching state.

The step S4 specifically comprises steps S41-S42.

The step S41 comprises determining whether the miss distance valid bits output by each of the sensors with the true miss distance valid bits in the time window comprise a non-true miss distance valid bits, if yes, outputting the azimuth angle measurement value and the pitch angle measurement value of one of the sensors with the highest priority and executing the step S43, if not, taking sensors only with the true miss distance valid bits in the time window as to-be-selected sensors and executing the step S42.

The step S42: comprises sorting priorities of the to-be-selected sensors according to the measurement precision, determining the working state of each of the to-be-selected sensors at the current moment by using the tri-state discrimination model, and outputting a current tracking result of the to-be-measured target by the photoelectric theodolite according to discrimination results.

The step S42 specifically comprises steps S421-S422.

The step S421 comprises if an output value at a previous moment is a fusion value, outputting the azimuth angle measurement value and the pitch angle measurement value of one of the to-be-selected sensors with the highest priority at the current moment, otherwise, outputting output values at the previous moment as the azimuth angle measurement value and the pitch angle measurement value of each of the to-be-selected sensors and executing step S422.

The step S422 comprises if the state of each of the to-be-selected sensors that outputs the azimuth angle measurement value and the pitch angle measurement value at the previous moment is in the fused state at the current moment, outputting an azimuth angle fusion value and a pitch angle fusion value of the to-be-selected sensors with the true valid bits at the current moment, otherwise, outputting the azimuth angle measurement value and the pitch angle measurement value of the one of the to-be-selected sensors with the highest priority at the current moment.

The step S43 comprises determining whether to continue to perform autonomous fusion tracking on the to-be-measured target, if yes, repeating the steps S41-S 42, and if not, ending autonomous fusion tracking of the to-be-measured target.

The output values at the previous moment change dynamically. The output values at the current moment are determined according to the output values at the previous moment to obtain a final output result.

Formulas for calculating the azimuth angle fusion value and the pitch angle fusion value are as follow:

$${\hat{X}}_{a} = {\sum }_{i = 1}^{c} {w}_{ai} {X}_{ai} ; and$$

$${\hat{X}}_{b} = {\sum }_{i = 1}^{c} {w}_{bi} {X}_{bi} .$$

\hat{X}ₐ is the azimuth angle fusion value, and \hat{X}_{b} is the pitch angle fusion value. The improvement measures of the least square extrapolation values maximize the detection of whether measurement data of each of the sensors has a large deviation and adjust the weighting factors in time.

The measurement values of each of the sensors comprise the azimuth angle measurement value and the pitch angle measurement value. The least square extrapolation values of each of the sensors comprise the azimuth least square extrapolation value and the pitch least square extrapolation value. The improved error covariance recursive formulas comprise an improved azimuth error covariance recursive formula and an improved pitch error covariance recursive formula. The error covariances of each of the sensors comprise an azimuth error covariance and a pitch error covariance. The weighting factors of each of the sensors comprise the azimuth weighting factor and the pitch weighting factor.

Based on the improved error covariance recursive formulas, the error covariances of each of the sensors at the current moment are calculated in real time, and the weighting factors of each of the sensors at the current moment are calculated in real time according to the error covariances of each of the sensors at the current moment. Then, the tri-state discrimination model is constructed based on the error covariances of each of the sensors at the current moment and the weighting factors of each of the sensors at the current moment. The tri-state discrimination model is configured to discriminate the working state of each of the sensors to be discriminated, and the working state of each of the sensors to be discriminated includes the holding state, the fused state, and the switching state. Based on the tri-state discrimination model, the working state of each of the effective sensors is discriminated, so that the photoelectric theodolite has autonomous, stable and reliable tracking capabilities in a closed-loop automatic tracking mode.

The tri-state discrimination model needs to use the error covariances of each of the sensors at the current moment and the weighting factors of each of the sensors at the current moment to discriminate the working state of each of the sensors to be discriminated. In a recursion of the error covariances, newly added error covariances represent deviation values of the data measurement of the sensors at a fusion moment, and the weighting factors of each of the sensors obtained from the error covariances represent an output dependence of different sensors at the same moment. These two are used together to determine whether the current sensor should switch or continue to be used to output the output values.

In any time period, at least one of the sensors is able to capture the to-be measured target, and at least one of the sensors for tracking is found to output a measurement result closest to a real state of the to-be measured target. Therefore, in the present disclosure, prioritizes of the sensors at different stages are sorted according to factory-set measurement precision of the sensors of the photoelectric theodolite, and autonomous switching of the sensors is realized according to the working state of each of the sensors and a priority sorting result thereof, thereby ensuring that at least one of the sensors that is currently selected has the highest authenticity of the measurement values.

As shown in FIG. 2, the photoelectric theodolite comprises four sensors. At a first moment, a miss distance valid bit of the first sensor and a miss distance valid bit of the third sensor are true, while a miss distance valid bit of the second sensor and a miss distance valid bit of the fourth sensor are non-true. Therefore, the first moment is taken as a starting effective moment of the first sensor and the third sensor, and a starting effective moment of the second sensor is the third moment. Since there are omitted moments of the fourth sensor, a starting effective moment of the fourth sensor is unable to be clearly pointed out. However, similarly, a moment when a miss distance valid bit of the fourth sensor first appears to be true is the starting effective moment of the fourth sensor.

It should be understood that various forms of the processes shown above may be reordered and the steps may be added or removed. For example, the steps described in the present disclosure may be performed at the same time, sequentially, or in a different order, as long as a desired result of technical solutions disclosed in the present disclosure can be implemented, which is not limited herein.

The above specific embodiments do not constitute a limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. An autonomous fusion tracking method based on sensors of a photoelectric theodolite, comprising:
a step S1: reading measurement values and miss distance valid bits of each of the sensors in real time, and calculating least square extrapolation values of each of the sensors at a current moment and average values of the measurement values of the sensors at the current moment according to real-time reading results; wherein the step S1 comprises:
a step S11: sorting priorities of the sensors according to measurement precision of the sensors, and reading an azimuth angle measurement value, a pitch angle measurement value, and a miss distance valid bit of each of the sensors at the current moment;
a step S12: determining whether there is a sensor with a true miss distance valid bit in the current moment, if yes, executing a step S13, if not, executing the step S11 and reading an azimuth angle measurement value, a pitch angle measurement value and a miss distance valid bit of each of the sensors at a next moment;
the step S13: obtaining the number of fusion values from a moment k−N_{fit}−k−1 of each of the sensors with the true miss distance valid bits, if each of the sensors with the true miss distance valid bits has N_{fit} fusion values from the moment k−N_{fit}−k−1, executing a step S14; and if not, executing a step S15;
the step S14: calculating an azimuth least square extrapolation value of each of the sensors with the true miss distance valid bits and a pitch least square extrapolation value of each of the sensors with the true miss distance valid bits at the current moment k by following formulas, and executing a step S2;
$${X}_{a p} ( k ) = {\sum }_{t = k - {N}_{f i t}}^{k - 1} β ( t ) {X}_{a f} ( t ) ;$$
$${X}_{b p} ( k ) = {\sum }_{t = k - {N}_{f i t}}^{k - 1} β ( t ) {X}_{b f} ( t ) ;$$
wherein β(t) is a coefficient, N_{fit} is the number of the fusion values required for fitting extrapolation values, Xₐₚ(k) is the azimuth least square extrapolation value at the current moment k, X_{bp}(k) is the pitch least square extrapolation value at the current moment k, X_{af}(t) is fusion values from the moment k−N_{fit}−k−1 in an azimuth dimension, and X_{bf}(t) is fusion values at the moment k−N_{fit}−k−1 in a pitch dimension; and
the step S15: calculating an average value of azimuth angle measurement values of the sensors with the true miss distance valid bits at the current moment k and an average value of pitch angle measurement values of the sensors with the true miss distance valid bits at the current moment k, defining the average value of the azimuth angle measurement values of the sensors with the true miss distance valid bits at the current moment k as a fusion value from the moment k−N_{fit}−k−1 in the azimuth dimension, defining the average value of the pitch angle measurement values of the sensors with the true miss distance valid bits at the current moment k as a fusion value from the moment k−N_{fit}−k−1 in the pitch dimension, and taking a reciprocal of a total number of the sensors with the miss distance valid bits at the current moment as an azimuth weighting factor and a pitch weighting factor at the current moment;
the step S2: substituting the least square extrapolation values respectively into improved error covariance recursive formulas, and calculating error covariances of each of the sensors at the current moment in real time based on the improved error covariance recursive formulas, and calculating weighting factors of the sensors at the current moment in real time according to the error covariances of each of the sensors at the current moment;
a step S3: constructing a tri-state discrimination model; and
a step S4: performing, by the photoelectric theodolite, autonomous fusion tracking on a to-be-measured target based on the tri-state discrimination model to obtain a tracking result.

2. The autonomous fusion tracking method according to claim 1, wherein the measurement values of each of the sensors comprise the azimuth angle measurement value and the pitch angle measurement value, the least square extrapolation values of each of the sensors comprise the azimuth least square extrapolation value and the pitch least square extrapolation value, the improved error covariance recursive formulas comprise an improved azimuth error covariance recursive formula and an improved pitch error covariance recursive formula, the error covariances of each of the sensors comprise an azimuth error covariance and a pitch error covariance, and the weighting factors of each of the sensors comprise the azimuth weighting factor and the pitch weighting factor.

3. The autonomous fusion tracking method according to claim 2, wherein the improved azimuth error covariance recursive formula and the improved pitch error covariance recursive formula are as follow:
$${\hat{σ}}_{a i}^{2} ( k ) = a {\hat{σ}}_{a i}^{2} ( k - 1 ) + ( 1 - a ) {( {X}_{a i} ( k ) - {X}_{a p} ( k ) )}^{2} ;$$
$${\hat{σ}}_{b i}^{2} ( k ) = a {\hat{σ}}_{b i}^{2} ( k - 1 ) + ( 1 - a ) {( {X}_{b i} ( k ) - {X}_{b p} ( k ) )}^{2} ;$$
wherein
$${\hat{σ}}_{a i}^{2} ( k )$$
is an error covariance or an i-th sensor in the azimuth dimension at the current moment k,
$${\hat{σ}}_{a i}^{2} ( k - 1 )$$
is an error covariance of the i-th sensor in the azimuth dimension at the (k−1)-th moment,
$${\hat{σ}}_{b i}^{2} ( k )$$
is an error covariance of the i-th sensor in the pitch dimension at the current moment k,
$${\hat{σ}}_{b i}^{2} ( k - 1 )$$
is an error covariance of the i-th sensor in the pitch dimension at the (k−1)-th moment, α is an attenuation factor and is 0.95, Xₐᵢ(k) is an azimuth angle measurement value of the i-th sensor at the current moment k, X_{bi}(k) is a pitch angle measurement value of the i-th sensor at the current moment k, Xₐₚ(k) is a least square extrapolation value at the current moment k in the azimuth dimension, and X_{bp}(k) is a least square extrapolation value at the current moment k in the pitch dimension.

4. The autonomous fusion tracking method according to claim 1, wherein in the step S4, the tri-state discrimination model is configured to discriminate a working state of each of the sensors to be discriminated, and the working state of each of the sensors to be discriminated comprises a holding state, a fused state, and a switching state.

5. The autonomous fusion tracking method according to claim 3, wherein the step S2 comprises:
a step S21: respectively substituting a real-time azimuth angle measurement value and a real-time pitch angle measurement value of each of the sensors into the improved azimuth error covariance recursive formula and the improved pitch error covariance recursive formula, and calculating the azimuth error covariance and the pitch error covariance of each of the sensors at the current moment in real time by the improved azimuth error covariance recursive formula and the improved pitch error covariance recursive formula; and
a step S22: substituting the azimuth error covariance and the pitch error covariance of each of the sensors at the current moment into following formulas to obtain the azimuth weighting factor and the pitch weighting factor of each of the sensors at the current moment:
$${w}_{ai} = \frac{1}{\vert {\hat{σ}}_{ai}^{2} {\sum }_{i = 1}^{n} 1 / {\hat{σ}}_{ai}^{2} ( k ) \vert} ;$$
$${w}_{bi} = \frac{1}{\vert {\hat{σ}}_{bj}^{2} {\sum }_{i = 1}^{n} 1 / {\hat{σ}}_{bi}^{2} ( k ) \vert} ;$$
wherein Wₐᵢ is an azimuth weighting factor of the i-th sensor, W_{bi} is a pitch weighting factor of the i-th sensor, and n is a total number of the sensors of the photoelectric theodolite.

6. The autonomous fusion tracking method according to claim 5, wherein determination steps of the tri-state discrimination model in the step S3 comprise:
a step S3A1: defining a time window as L time sampling points including the current moment, and calculating a residual error absolute value Mₐᵢ(t) of the error covariance of the azimuth angle measurement value and a residual error absolute value M_{bi}(t) of the error covariance of the pitch angle measurement value;
a step S3A2: reading the azimuth angle measurement value and the pitch angle measurement value of a current to-be-discriminated sensor in the time window;
a step S3A3: determining whether there are L time sampling points in the time window of the current to-be-discriminated sensor, if yes, executing a step S3A4, if not, executing the step S3A2 until there are L time sampling points in the time window of the current to-be-discriminated sensor;
the step S3A4: when the residual error absolute values Mₐᵢ(t) or the residual error absolute value M_{bi}(t) of each of the time sampling points of the current to-be-discriminated sensor in the time window is greater than a first threshold, or when there is the residual error absolute values Mₐᵢ(t) or the residual error absolute value M_{bi}(t) of the current to-be-discriminated sensor in the time window that is greater than the first threshold, and the azimuth weighting factor and the pitch weighting factor of each of the time sampling points are less than a second threshold, determining that the current to-be-discriminated sensor is in the switching state and executing a step S3A6, otherwise, performing a next determination step on the current to-be-discriminated sensor and executing a step S3A5;
the step S3A5: when the residual error absolute values Mₐᵢ(t) and the residual error absolute value M_{bi}(t) of each of the time sampling points of the current to-be-discriminated sensor in the time window are less than the first threshold, or when there are the residual error absolute values Mₐᵢ(t) and the residual error absolute value M_{bi}(t) of the current to-be-discriminated sensor in the time window that are less than the first threshold, and the azimuth weighting factor and the pitch weighting factor of each of the time sampling points are greater than the second threshold, determining that the current to-be-discriminated sensor is in the holding state, otherwise, determining that the current to-be-discriminated sensor is in the fused state; and
the step S3A6: repeating the steps S3A2-S3A5 to realize a tri-state discrimination of all of the sensors to be discriminated.

7. The autonomous fusion tracking method according to claim 6, wherein a formula for calculating the residual error absolute value Mₐᵢ(t) of the error covariance of the azimuth angle measurement value obtained according to the azimuth angle measurement value of the sensors to be discriminated at the current moment is:
$${M}_{ai} ( t ) = \vert {X}_{ai} ( t ) - {X}_{ap} ( t ) \vert ;$$
wherein Xₐᵢ(t) is the azimuth angle measurement value of one of the sampling points at a t moment of each of the sensors to be discriminated, t=k−L+1, k−L+2, . . . , k, L is a length of the time window, k is the current moment, and Xₐₚ(t) is the azimuth least square extrapolation value of each of the sensors to be discriminated at the moment t;
wherein a formula for calculating the residual error absolute value M_{bi}(t) of the error covariance of the pitch angle measurement value obtained according to the pitch angle measurement value of each of the sensors to be discriminated at the current moment is:
$${M}_{bi} ( t ) = \vert {X}_{bi} ( t ) - {X}_{bp} ( t ) \vert ;$$
wherein X_{bi}(t) is the pitch angle measurement value of each of the sensors to be discriminated at the moment t, and X_{bp}(t) is the pitch least square extrapolation value of each of the sensors to be discriminated at the moment t;
wherein another formula for calculating the residual error absolute value Mₐᵢ(t) of the error covariance of the azimuth angle measurement value obtained according to the azimuth angle measurement value of the sensors to be discriminated at the current moment is:
$${M}_{ai} ( t ) = \vert {X}_{ai} ( t ) - {X}_{af} ( t ) \vert ;$$
wherein X_{af}(t) is a fusion value from the t−N_{fit}−t−1 moment in the azimuth dimension;
wherein another formula for calculating the residual error absolute value M_{bi}(t) of the error covariance of the pitch angle measurement value obtained according to the pitch angle measurement value of each of the sensors to be discriminated at the current moment is:
$${M}_{bi} ( t ) = \vert {X}_{bi} ( t ) - {X}_{bf} ( t ) \vert ;$$
wherein X_{bf}(t) is a fusion value from the t−N_{fit}−t−1 moment in the pitch dimension;

8. The autonomous fusion tracking method according to claim 7, wherein the step S4 comprises:
a step S41: determining whether the miss distance valid bits output by each of the sensors with the true miss distance valid bits in the time window comprises non-true miss distance valid bits, if yes, outputting the azimuth angle measurement value and the pitch angle measurement value of one of the sensors with the highest priority and executing a step S43, if not, taking sensors only with the true miss distance valid bits in the time window as to-be-selected sensors and executing a step S42;
the step S42: sorting priorities of the to-be-selected sensors according to the measurement precision, determining the working state of each of the to-be-selected sensors at the current moment by using the tri-state discrimination model, and outputting a current tracking result of the to-be-measured target by the photoelectric theodolite according to discrimination results; and
the step S43: determining whether to continue to perform autonomous fusion tracking on the to-be-measured target, if yes, repeating the steps S41-S42, and if not, ending autonomous fusion tracking of the to-be-measured target.

9. The autonomous fusion tracking method according to claim 8, wherein the step S42 comprises:
a step S421: if an output value at a previous moment is a fusion value, outputting the azimuth angle measurement value and the pitch angle measurement value of one of the to-be-selected sensors with the highest priority at the current moment, otherwise, outputting output values at the previous moment as the azimuth angle measurement value and the pitch angle measurement value of each of the to-be-selected sensors and executing a step S422;
the step S422: if the state of each of the to-be-selected sensors that outputs the azimuth angle measurement value and the pitch angle measurement value at the previous moment is in the fused state at the current moment, outputting an azimuth angle fusion value and a pitch angle fusion value of the to-be-selected sensors with the true valid bits at the current moment, otherwise, outputting the azimuth angle measurement value and the pitch angle measurement value of the one of the to-be-selected sensors with the highest priority at the current moment.

10. The autonomous fusion tracking method according to claim 9, wherein formulas for calculating the azimuth angle fusion value and the pitch angle fusion value are as follow:
$${\hat{X}}_{a} = {\sum }_{i = 1}^{c} {w}_{ai} {X}_{ai} ;$$
$${\hat{X}}_{b} = {\sum }_{i = 1}^{c} {w}_{bi} {X}_{bi} ;$$
wherein \hat{X}ₐ is the azimuth angle fusion value, and \hat{X}_{b} is the pitch angle fusion value.
